(19) United States
(12) Patent Application Publication
(10) Pub. No.: US 2020/0074314 A1
(43) Pub. Date: Mar. 5, 2020

(54) KNOWLEDGE PRODUCTION SYSTEM

(71) Applicant: FANUC CORPORATION, Minamitsuru-gun (JP)

(72) Inventors: Masao KAMIGUCHI, Yamanashi (JP); Koji SAMUKAWA, Yamanashi (JP); Noriaki NEKO, Yamanashi (JP); Shouichi KAWAKAMI, Yamanashi (JP); Sumire OKUAKI, Yamanashi (JP)

(21) Appl. No.: 16/552,170

(22) Filed: Aug. 27, 2019

(30) Foreign Application Priority Data
Aug. 31, 2018 (JP) 2018-162645

(51) Int. Cl. G06N 5/02; G06N 5/04; G06F 11/00; G07C 9/00

(52) U.S. Cl. CPC G06N 5/02; G06N 5/041; G07C 9/00912; G06F 11/008; G06N 5/046

(57) ABSTRACT

An object is to provide a knowledge production system which can efficiently produce knowledge information from less confidential information. A knowledge production system includes: a data reception part that receives, when an event occurs in a unit, only data after a time at which to go back only a preset time until the occurrence of the event; and a production part that extracts, from the received data and data received in the past by the occurrence of the same event as the event, a feature amount on the event so as to produce knowledge information of the event.

This application is based on and claims the benefit of priority from Japanese Patent Application No. 2018-162645, filed on 31 Aug. 2018, the content of which is incorporated herein by reference.

### BACKGROUND OF THE INVENTION

### Field of the Invention

The present invention relates to a system which produces knowledge information on the operation of units.

### Related Art

Knowledge information, such as an operation manual and a maintenance manual of a machine, knowledge of how to handle a machine, the condition diagnosis of a machine in the middle of machining and a machining diagnosis after machining, is present which is accumulated on each unit such as a machine or a device and which includes various findings and experiences. For example, Patent Document 1 proposes a technology in which the details of an alarm occurring in a machine tool and a handling method are received, and in which a correlation between the alarm and the handling method is learned for each type of alarm.

Patent Document 1: Japanese Unexamined Patent Application, Publication No. 2018-97494

### SUMMARY OF THE INVENTION

However, data on which knowledge information is produced based is, for example, the observation data, the state data and the like of a machine tool, and the data in a continuous period may be highly confidential information such as advanced knowledge of how to perform machining.

An object of the present invention is to provide a knowledge production system which can efficiently produce knowledge information from less confidential information.

(1) A knowledge production system (for example, a knowledge production system 10 which will be described later) according to the present invention includes: a data reception unit (for example, a data reception unit 131 which will be described later) that receives, when an event occurs in a unit (for example, a units 12 which will be described later), only data after a time at which to go back only a preset time until the occurrence of the event; and a production unit (for example, a production unit 132 which will be described later) that extracts, from the received data and data received in the past by the occurrence of the same event as the event, a feature amount on the event so as to produce knowledge information of the event.

(2) In the knowledge production system described in (1), the event may be the occurrence of an abnormal state in the unit, a predetermined operation input to the unit or a change of an operation environment of the unit.

(3) In the knowledge production system described in (1) or (2), the data reception unit may receive, when an edge server (for example, an edge server 11 which will be described later) to which a plurality of the units is connected detects the event, the data from the edge server.

(4) In the knowledge production system described in any one of (1) to (3), the data reception unit may receive data of an item which is preset for each of the units and each of the events.

(5) In the knowledge production system described in any one of (1) to (4), the time may be preset for each of the units and each of the events.

According to the present invention, it is possible to efficiently produce knowledge information from less confidential information.

### BRIEF DESCRIPTION OF THE DRAWINGS

FIG. 1 is a block diagram showing the configuration of a knowledge information service system according to an embodiment;

FIG. 2 is a block diagram showing the function of a knowledge production system according to the embodiment;

FIG. 3 is a diagram illustrating an example of parameters set in an event manager in the embodiment;

FIG. 4 is a block diagram showing the function of an operation service system according to the embodiment;

FIG. 5 is a diagram illustrating an example of interface items included in a data API in the embodiment; and

FIG. 6 is a diagram showing an example of a screen display by a data API in the embodiment.

### DETAILED DESCRIPTION OF THE INVENTION

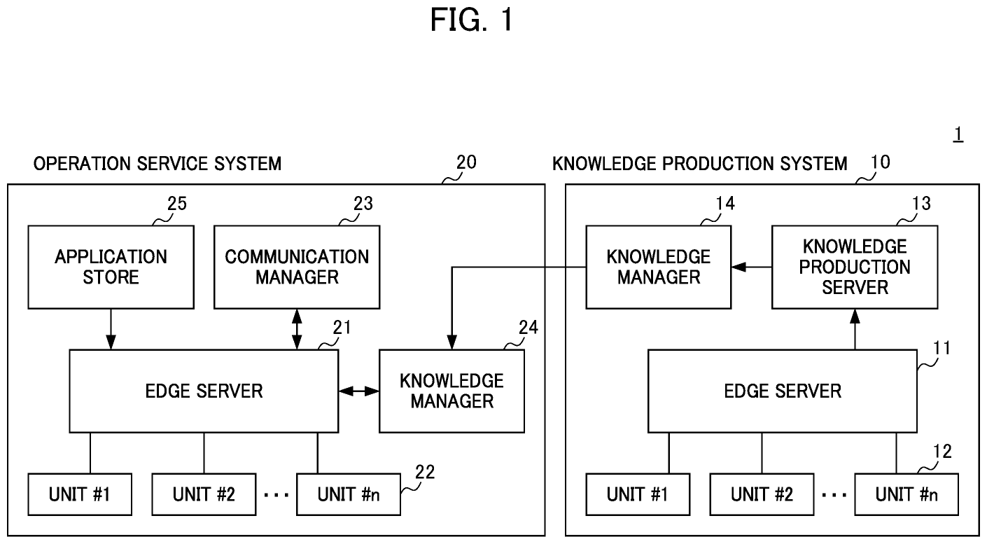

An example of the embodiment of the present invention will be described below. FIG. 1 is a block diagram showing the configuration of a knowledge information service system 1 according to the present embodiment. The knowledge information service system 1 includes a knowledge production system 10 which produces knowledge information and an operation service system 20 which operates the produced knowledge information. Although in the present embodiment, the knowledge production system 10 and the operation service system 20 are described as two independent systems, edge servers (11 and 21), units (12 and 22) and knowledge managers (14 and 24) may be shared.

In the knowledge production system 10, a knowledge production server 13 collects various types of information such as measurement data and operation data obtained from a plurality of units 12 through the edge server 11, a manual and knowledge of how to perform machining. The knowledge production server 13 uses an AI engine such as machine learning or deep learning so as to organize the collected information, and thereby produces knowledge information. The produced knowledge information is made to correspond to the AI engine and is stored in the knowledge manager 14.

The operation service system 20 provides application software (knowledge providing program) which includes an interface for utilization of the knowledge information produced by the knowledge production system 10 as a package, specifically, as a data API (Application Programming Interface) that is operated in the edge server 21. In this way, the operation service system 20 publishes, through the data API, the knowledge information based on findings, experiences and the like owned by engineers. The data API described above is sold at an application store 25 which is a website so as to bill a user, and thus the producer of the knowledge information receives the value of the produced knowledge information.

The user of the edge server 21 purchases, through the application store 25, the data API for utilization of the knowledge information stored in a knowledge manager 24. When the data API is installed, a communication manager 23 monitors an abnormality in the operation of the data API and an operation period. For example, when resources for utilization of the data API are insufficient, the communication manager 23 outputs alarm information on an abnormality in the operation of the data API to a screen whereas when the usage period is restricted, the communication manager 23 outputs information of the usage period, and alarm information showing that the data API cannot be used or the like to the screen.

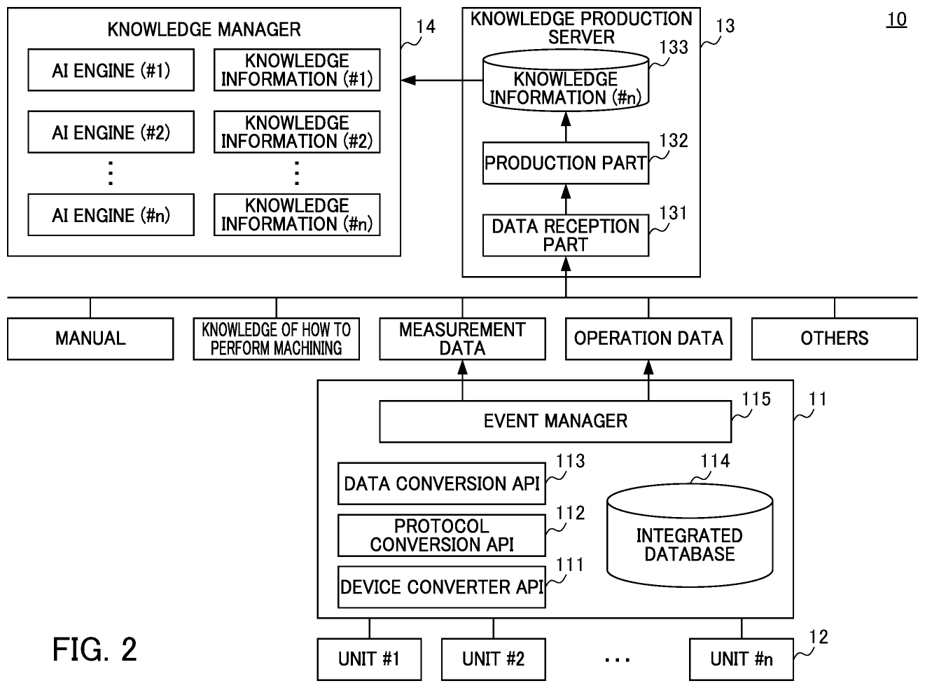

FIG. 2 is a block diagram showing the function of the knowledge production system 10 according to the present embodiment. The knowledge production system 10 includes the edge server 11, a plurality of units 12 which are connected to the edge server 11, the knowledge production server 13 and the knowledge manager 14.

The edge server 11 includes a device converter 111, a protocol conversion API 112, a data conversion API 113, an integrated database 114 and an event manager 115.

At least one of the units 12 such as a machine tool, an industrial machine, a robot, a PLC (Programmable Logic Controller) device, a switch and a sensor is connected to the edge server 11. The units 12 connected to the edge server 11 are physically connected by utilization of the device converter 111 which allows a hardware connection to the edge server 11. At least one device converter 111 is provided in order to absorb the differences of hardware interfaces of the individual units 12 such as I/O, RS232C, RS422 and Ethernet and to connect the units 12 to the edge server 11 such that they communicate with each other. The device converter 111 may be attached independently of the edge server 11 so as to correspond to each of the units 12.

Data can be transmitted and received to and from the connected units 12 by utilization of protocols corresponding to the units 12. At least one protocol conversion API 112 is provided in order to absorb the differences of the protocols for capturing the data.

When data is individually received from the same type of units 12, it is preferable to make the configuration of the received data uniform so as to enhance convenience. For example, when the connected units 12 are CNCs (Computerized Numerical Controllers), in order not to depend on manufacturing makers, the data conversion API 113 converts the types of CNCs, manufacturing numbers, program numbers being currently executed, the number of axes used, parameters for operating the individual axes, commands for speeds at the time of operation, load torques, current positions and the like such that they have a predetermined format and a predetermined order. At least one data conversion API 113 is provided in order to rearrange a data group after being subjected to protocol conversion with the protocol conversion API 112 such that the data group has unified items and order.

As described above, the data conversion API 113 may use information provided from unit makers to rearrange the received data such that a predetermined data arrangement is provided. Alternatively, the data conversion API 113 may be an application which is produced by each of the unit markers such that the received data is rearranged to have a determined data arrangement.

The data obtained by conversion with the protocol conversion API 112 and the data conversion API 113 is stored in the integrated database 114. The data subjected to the protocol conversion may be temporarily stored in the integrated database 114 so as to be updated with the data conversion API 113 or the data may be subjected to the protocol conversion and then data conversion so as to be stored in the integrated database 114.

The event manager 115 extracts, according to extraction items and an extraction method when an event occurs which are previously set as parameters on each of the units 12, among logs received from the individual units 12 and accumulated in the integrated database 114, data during a predetermined period, that is, an event log, and transmits it to the knowledge production server 13. The predetermined period specifically refers to a period until the occurrence of an event after a time at which to go back only a preset time (for example, 5 minutes) from the occurrence of the event.

Here, the event is the occurrence of an abnormal state such as an alarm in the unit 12, a machining failure or a function failure of the unit 12 which occurs at present or occurred in the past, a predetermined operation input to the unit 12 or the edge server 11, a change of the operation environment of the unit 12 or the like, and an event ID is provided to each event and is preset to the event manager 115.

The event logs of the individual units 12 extracted from the integrated database 114 are grouped by the same event in the knowledge production server 13, and a feature is extracted for each group. The extraction of the feature may be performed each time the edge server 11 detects the occurrence of an event so as to transmit data or may be produced when a request for production of knowledge information is received.

In the integrated database 114, regardless of whether or not an event occurs, the measurement data, the operation data and the like of the units 12 in the past may be accumulated. The individual units 12 connected to the edge server 11 store, in the integrated database 114, various types of data occurring at the time of operation, for example, items set in the event manager 115.

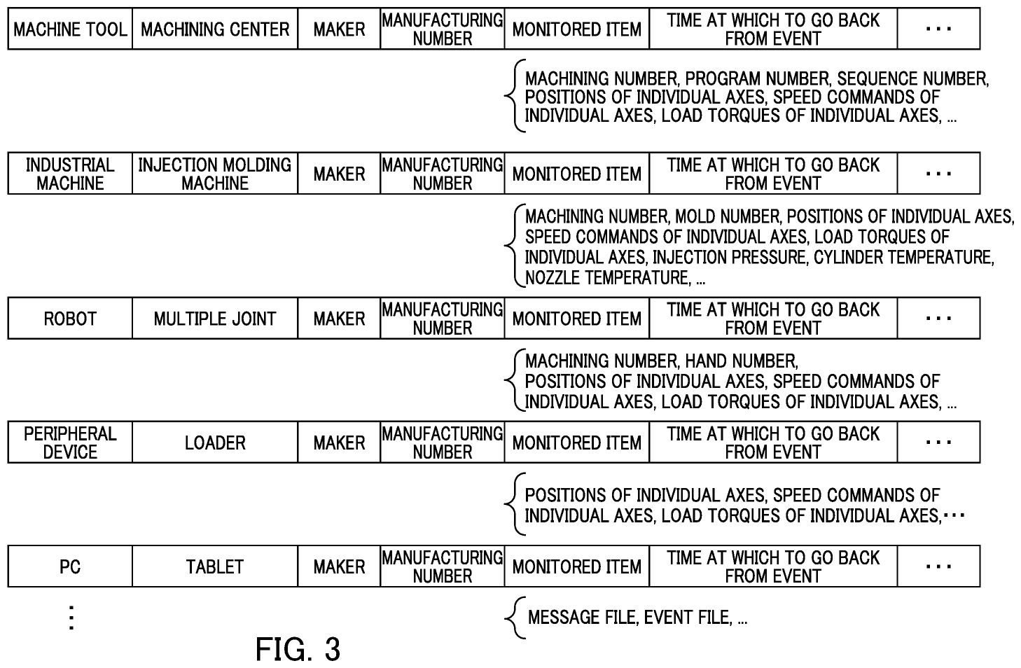

FIG. 3 is a diagram illustrating an example of parameters which are set in the event manager 115 in the present embodiment and which specify the extraction items and the extraction method. In the parameters, as key information of data acquired from the units 12, the types of units 12 are set. For example, when the units 12 are machine tools, types such as a machining center, a lathe and a grinding machine, the manufacturing makers of the units 12, the manufacturing numbers and the like are set. Furthermore, as the key information, the event IDs or names may be added.

As the data (the measurement data and the operation data) when the units 12 are operated, items which are monitored are set. A sampling time, for example, 1 ms, is determined based on the specifications of the edge server 11. Examples of the item which is monitored include a machining number, a program number, a sequence number, the positions of individual axes, the speed commands of the individual axes and the load torques of the individual axes, and they are set according to the types of units 12.

When the units 12 are personal computers or tablet terminals, the monitor item may be the contents of a predetermined message file, an event file and the like, message data produced by software for message production or the like. This software itself may notify message data to the event manager 115 or the event manager 115 may monitor the writing of message data with this software such that it is processed as an event.

As the time at which to go back from the event, which data in a certain period in the past is utilized for production of knowledge information is set based on a time when the event occurs.

The event manager 115 receives an input operation for these items so as to set them as parameters for specifying the extraction items and the extraction method. Here, a plurality of parameter values which are previously prepared may be selected by a drop-down method or the like.

The knowledge production server 13 includes a data reception part 131 and a production part 132, and produces knowledge information. When an event such as an alarm occurs in any one of the units 12, and the edge server 11 detects this event, the data reception part 131 receives, from the edge server 11, only data after a time at which to go back only a time preset for each of the units 12 and each event until the occurrence of the event. Here, the data reception part 131 receives the data of items which are preset for each of the units 12 and each event.

The production part 132 extracts, from the received data and data received in the past by the occurrence of the same event as the event, a feature amount on the event so as to produce the knowledge information 133 of the event.

The knowledge production server 13 manages the knowledge information of data such as manuals and knowledge of how to perform machining which is already present together with the knowledge information of the measurement data and the operation data observed in the operations of the units 12.

The knowledge information of data such as manuals which is already present can be collected by, for example, a method proposed in Japanese Unexamined Patent Application, Application No. 2018-094550. As data which is input, a plurality of pieces thereof may be provided simultaneously. For example, when as data #1, the manual, the knowledge of how to perform machining, the measurement data and the operation data are provided simultaneously, the production part 132 can produce knowledge information obtained by extracting the features thereof. Answers to inquiries can be collected by, for example, a method proposed in Japanese Unexamined Patent Application, Application No. 2017-159990 from knowledge information obtained by organizing the cause and countermeasure information of the past maintenance results and the like.

Data when the unit 12 is operated will be described using a machine tool as an example. When an event such as an alarm occurs in a machine tool, the event manager 115 extracts, from the data stored in the integrated database 114, data corresponding to a period after which to go back from the occurrence of the event and which is set in the event manager 115 together with the type of machine tool, information of a controller used, the names of parts, a current program number, a tool number, a material number, an alarm number and the like, and transmits it to the knowledge production server 13. Here, the information of a peripheral device and the like which are attached to the machine tool may likewise be sent. For example, when a tablet terminal is attached to the machine tool, and an operator inputs information to this tablet terminal, this information is also sent to the knowledge production server 13.

In the knowledge production server 13, for each event, the names of parts, the program number, the tool number, the material number, the alarm number, a machining number, a machining date and time and the like are used as keys, and data at the time of the past machining is organized by FFT (Fast Fourier Transform), main component analysis or the like so as to be stored as knowledge information. Here, the knowledge production server 13 also extracts features from text data input by the operator through the tablet terminal or the like so as to store them. A method of extracting the features from the data and organizing them is not limited, and waveform data acquired from the units 12 may be stored without being processed.

When voice data is present, the knowledge production server 13 may convert the voice data into text and thereafter perform analyzation so as to extract feature data. Furthermore, the knowledge production server 13 associates, for example, data measured with a shape measuring unit or the like after machining with the machining number, the machining date and time and the like, and utilizes it for factor analysis on the details of an inquiry.

The knowledge information produced in this way is accumulated in the knowledge manager 14 for each event, and integrated knowledge information on one type of machining is collected. The knowledge manager 14 associates the produced knowledge information with the AI engine used when the knowledge information is produced so as to manage a plurality of combinations.

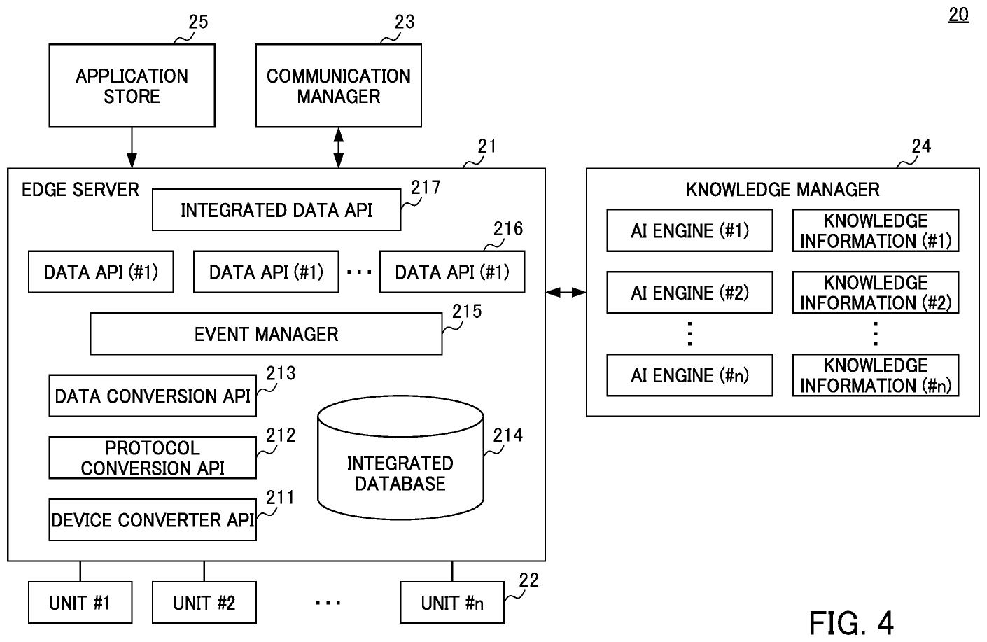

FIG. 4 is a block diagram showing the function of the operation service system 20 according to the present embodiment. The operation service system 20 includes the edge server 21 (knowledge providing device), a plurality of units 22 which are connected to the edge server 21, the communication manager 23, the knowledge manager 24 and the application store 25. A plurality of edge servers 21 may be provided for the application store 25 and the communication manager 23.

The edge server 21 includes, as with the edge server 11 of the knowledge production system 10, a device converter 211, a protocol conversion API 212, a data conversion API 213, an integrated database 214 and an event manager 215, and further includes a data API 216 and an integrated API 217.

When the event manager 215 detects the occurrence of an event, the event manager 215 may automatically input, as data related to the event, the measurement data and the operation data in a predetermined period before the occurrence of the event to the data API 216. Alternatively, the related data may be input to the data API 216 according to an input operation together with a message when an inquiry is received from the user.

The data API 216 may be purchased according to the type of knowledge information (for example, the unit 22 or a unit group) from the application store 25. When a plurality of pieces of data API 216 are present, the integrated API 217 integrates handling of the plurality of pieces of data API 216 and provides, for example, a function of operating a plurality of types of knowledge information on one operation screen.

The communication manager 23 is configured with software which manages the state of operation of the edge server 21. For example, when in the edge server 21, the use of the data API 216 (#1) which is purchased under a one-year contract is close to the usage period of one year, the communication manager 23 provides a warning notification to the user, and stops the operation of the data API (#1) when continuation processing is not performed within an allowable period.

The knowledge manager 24 interprets an inquiry for the cause of or a countermeasure against the event from the data API 216 so as to send back an answer to the inquiry and necessary data to the data API 216. The knowledge manager 24 may be the same as the knowledge manager 14 of the knowledge production system 10 or may be a copy of the knowledge manager 14 made in the knowledge production system 10.

The application store 25 is a website which sells the data API 216 that is an application for utilization of the knowledge information stored in the knowledge manager 24. The user visits the application store 25, purchases dedicated data API 216 for utilization of necessary knowledge information and installs it into the edge server 21.

The application store 25 may further sell and manage a knowledge production program for registering knowledge information in the knowledge manager 24. The knowledge production program corresponds to a program which is executed in the production part 132 of the knowledge production server 13, and shares part of an algorithm when the knowledge manager 24 produces an answer.

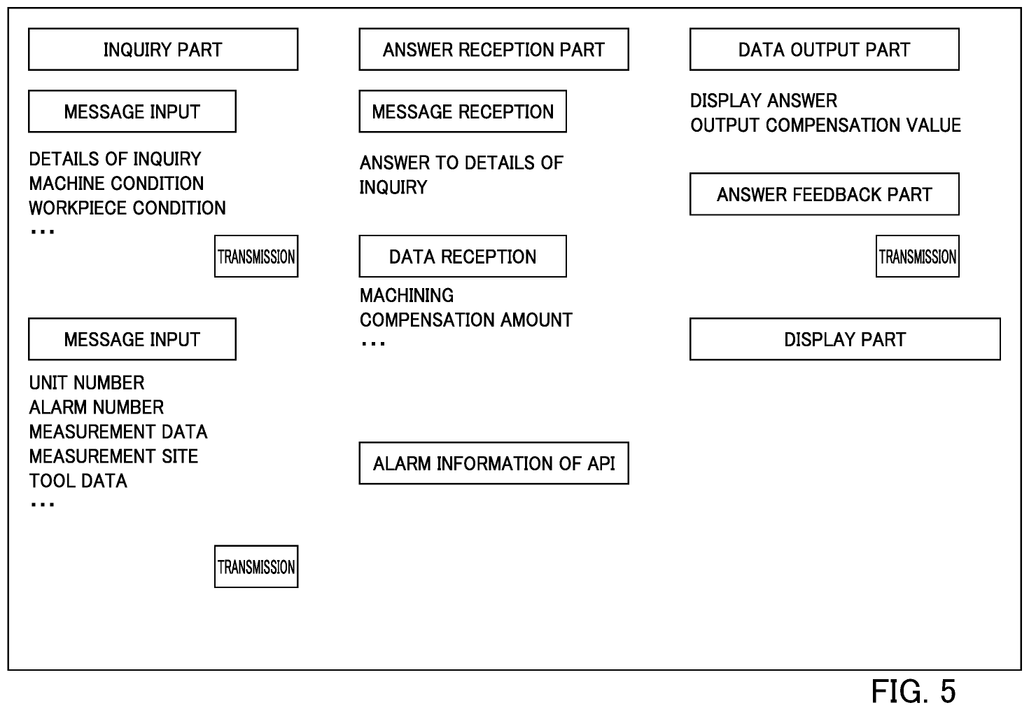

FIG. 5 is a diagram illustrating an example of interface items included in the data API 216 in the present embodiment. The data API 216 includes an inquiry part to the knowledge manager 24 and an answer reception part which receives an answer (message) and related data from the knowledge manager 24.

The details of an inquiry such as the condition of a machine or the condition of a workpiece are input as a message input to the inquiry part, and additional information such as a unit number, the alarm number, the measurement data, a measurement site and tool data is input as a data input. An answer to the details of the inquiry is output as message reception to the answer reception part, and related information such as a machining compensation amount is output as data reception.

The data API 216 can transfer, in a data output part, data such as a compensation value to the units 22 connected to the edge server 21. Examples of the compensation value include a compensation value for the speed of machining and a compensation value for the torque of machining. In the data output part, for example, candidates for compensation data are displayed, and the user presses a transmission button as necessary so as to be able to transmit the compensation data to the unit 22 which is previously selected.

The data API 216 produces, in a display part, a graph display according to the details of the message input, the message reception or the data reception. The data API 216 may receive, in an answer feedback part, a feedback input for the answer obtained in the answer reception part. The data API 216 may also output, to the screen, the information of an abnormality in the operation of the data API, the information of the usage period and the alarm information such as information indicating that it cannot be used which are detected with the communication manager 23.

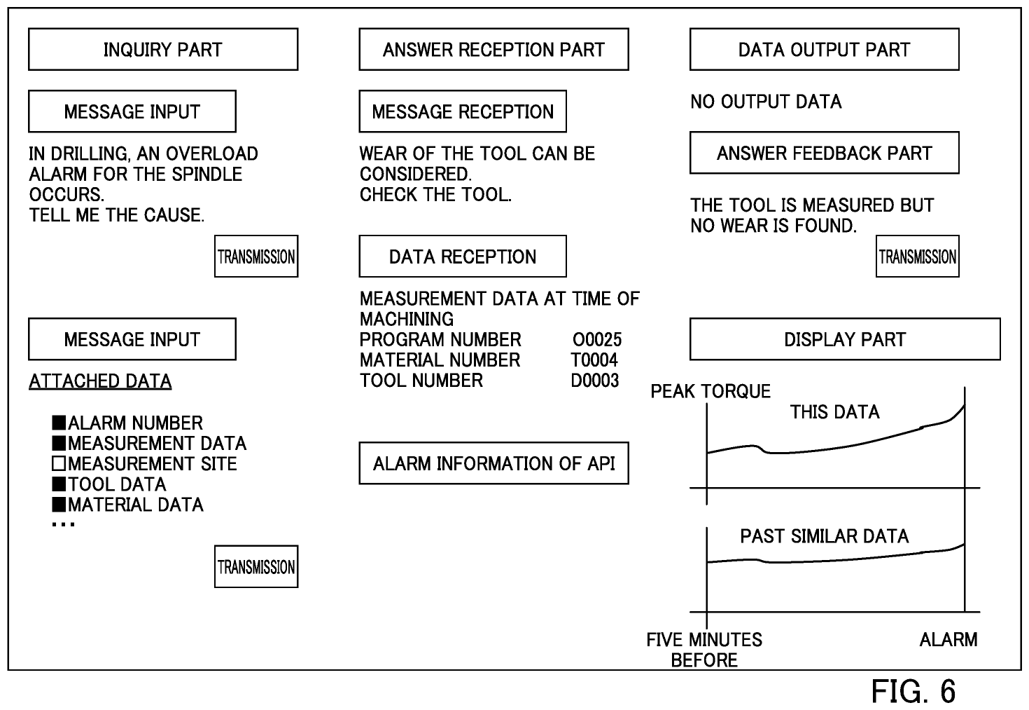

FIG. 6 is a diagram showing an example of the screen display by the data API 216 in the present embodiment. The user inputs, for example, “In drilling, an overload alarm for the spindle occurs. Tell me the cause.” in the field of the message input, and sends it to the knowledge manager 24. Hence, the knowledge manager 24 utilizes an AI engine for message decryption so as to check the details of the message. For example, the character string of the message input is broken down into the “drilling”, the “spindle”, the “overload alarm”, the “cause”, the “tell me” and the like, and thus information on the “drilling”, the “spindle” and the “overload alarm” is collected. Here, the knowledge manager 24 also analyzes the alarm number, the measurement data, the tool data and the material data attached to the field of the data input with individually necessary AI engines, and searches for similar data.

The knowledge manager 24 extracts, in the individual pieces of information, a data group in which the degree of similarity is the highest, and uses an answer in the past data group as an answer for this inquiry. In the example of the figure, the knowledge manager 24 outputs the data, for example, in the past five minutes from events in which an alarm occurs as the measurement data at the time of machining, the program number, the material number and the tool number. The knowledge manager 24 also outputs, from the degree of similarity to the peak torque of the spindle in five minutes before the occurrence of the event displayed in the display part, a message for a failure phenomenon occurring in the past “Wear of the tool can be considered. Check the tool.”

In this example, since a compensation value for the unit 22 which is connected is not present, a message “No output data” is displayed in the data output part.

Furthermore, the user may transmit feedback for the failure message in the answer reception part to the knowledge manager 24. In the example of the figure, as an example, a message “The tool is measured but no wear is found.” is transmitted to the knowledge manager 24. In this case, since the failure message indicating that the wear of the tool can be considered differs from the result of the feedback, the knowledge manager 24 may search for the second-highest possible failure message and provide an answer again. Alternatively, regardless of whether or not the failure message agrees with the result of the feedback, the knowledge production system 10 may update the knowledge information based on the result of the feedback.

As a method of using the feedback as the answer, for example, the data API 216 may display a question “Is this answer useful?” on the screen, prompt the user to select a button of “yes” or “no” and receive an input of specific details when the “no” is selected.

As described above, the knowledge production system 10 uses an AI engine (# n) so as to generate or update knowledge information (# n). The operation service system 20 uses, according to access from a data API 216 (# n), the AI engine (# n) so as to search for the knowledge information (# n). The producer of the knowledge information (# n) uses the AI engine (# n) so as to develop the data API 216 (# n) for utilization of the knowledge information (# n), and sells it at the application store 25. In order to utilize the knowledge information (# n), the user purchases the data API 216 (# n) from the application store 25 or purchases a usage license. In this way, the producer of the knowledge information (# n) can receive the value of the produced knowledge information (# n).

In the present embodiment, the knowledge production system 10 utilizes, according to the occurrence of an event, data until the occurrence of the event after a time at which to go back only a preset time and extracts a feature amount from the data group of each event so as to produce knowledge information for the individual event. Hence, the knowledge production system 10 acquires only data in a limited period, and thus the whole of the machining is not disclosed, with the result that the leakage of knowledge of how to perform the machining and the like is reduced. Consequently, the knowledge production system 10 can efficiently produce knowledge information from less confidential data.

Since an event which serves as a reference for production of knowledge information is previously defined as the occurrence of an abnormal state in the unit 12, a predetermined operation input to the unit 12, a change of the operation environment of the unit 12 or the like, the knowledge production system 10 can efficiently acquire various types of data with characteristic timing and can automatically produce useful knowledge information without depending on the memory of each person.

The edge server 11 to which a plurality of units 12 are connected detects events so as to transmit data on the target units 12 to the knowledge production server 13, and thus the knowledge production system 10 can efficiently produce knowledge information using various units 12 as targets.

The knowledge production system 10 receives data of items which are preset for each of the units 12 and each event so as to reduce the amount of data handled, and thereby can efficiently produce knowledge information.

A time at which to go back from the occurrence of the event in order to acquire data is preset for each of the units 12 and each event, and thus the knowledge production system 10 acquires data in an appropriate period so as to match the characteristics of various units 12 and events, and thereby can efficiently produce knowledge information.

In order to provide the produced knowledge information, in the operation service system 20, a dedicated application is interposed, and this application makes an inquiry to the knowledge manager 24 so as to receive and output data including an answer. Hence, the dedicated application is sold, and thus the producer of knowledge information can easily provide knowledge information and receive the value thereof while limiting the provision destinations of information.

The dedicated application is installed as the API so as to be easily incorporated in the edge server 21, and thus it is possible to provide an appropriate user interface.

Since the dedicated application receives feedback from the user and provides it to the knowledge manager 24, it is possible to update the produced knowledge information to highly valuable information so as to provide it to the user.

In the operation service system 20, the edge server 11 detects the occurrence of an event, automatically inputs the measurement data and the operation data in a predetermined period until the occurrence of the event as an inquiry or the related data of the inquiry to the data API 216 and thereby can efficiently make an inquiry.

The operation service system 20 further sells and manages the knowledge production program for producing knowledge information and registering it in the knowledge manager 24, and thereby can provide a mechanism from the production of knowledge information to the utilization thereof. An algorithm is shared in the production of knowledge and the production of an answer, and thus the accuracy of a search is enhanced, with the result that the value of utilization of the knowledge information service system 1 is enhanced.

Since the producer of knowledge information utilizes the knowledge production system 10, and thereby can automatically produce knowledge information, it is not necessary to specially take time for the production of knowledge information. Since in the utilization of knowledge information, the producer of knowledge information only provides the data API 216 to the user, it is not necessary to specially take time for development. Furthermore, the producer of knowledge information can receive the value of knowledge information by selling the data API 216.

Although the embodiment of the present invention is described above, the present invention is not limited to the embodiment described above. The effects described in the present embodiment are simply a list of the most preferred effects produced from the present invention, and the effects of the present invention are not limited to those described in the present embodiment.

A knowledge information service method with the knowledge information service system 1 is realized by software. When it is realized by software, programs forming this software are installed into a computer. These programs may be recorded in removable media so as to be distributed to users or may be downloaded into the computers of the users so as to be distributed.

### EXPLANATION OF REFERENCE NUMERALS

1 knowledge information service system
10 knowledge production system
11 edge server
12 unit
13 knowledge production server
14 knowledge manager
20 operation service system
21 edge server
22 unit
23 communication manager
24 knowledge manager
25 application store
114 integrated database
115 event manager
131 data reception part
132 production part
133 knowledge information
211 device converter
214 integrated database
215 event manager
216 data API
217 integrated API 24

What is claimed is:

1. A knowledge production system comprising:
a data reception part that receives, when an event occurs in a unit, only data after a time at which to go back only a preset time until the occurrence of the event; and
a production part that extracts, from the received data and data received in a past by an occurrence of a same event as the event, a feature amount on the event so as to produce knowledge information of the event.

2. The knowledge production system according to claim 1,
wherein the event is an occurrence of an abnormal state in the unit, a predetermined operation input to the unit or a change of an operation environment of the unit.

3. The knowledge production system according to claim 1,
wherein the data reception part receives, when an edge server to which a plurality of the units are connected detects the event, the data from the edge server.

4. The knowledge production system according to claim 1,
wherein the data reception part receives data of an item which is preset for each of the units and each of the events.

5. The knowledge production system according to claim 1,
wherein the time is preset for each of the units and each of the events.
